(19) United States
(12) Patent Application Publication
(10) Pub. No.: US 2007/0298401 A1
(43) Pub. Date: Dec. 27, 2007

(54) Educational System and Method Using Remote Communication Devices

(76) Inventors: Subhashis Mohanty, San Diego, CA (US); Sara Mohanty, San Diego, CA (US)

Correspondence Address: WILLIAM J. KOLEGRAFF, 3119 TURNBERRY WAY, JAMUL, CA, 91935, US

(21) Appl. No.: 11/423,931

(22) Filed: Jun. 13, 2006

(51) Int. Cl. G09B 3/00

(52) U.S. Cl. 434/350

(57) ABSTRACT

A system and method is provided for using common communication devices to deliver educational lessons to students. The system is able to determine that an authorized student is attempting to access an educational program, and retrieves educational goals and progress information specific to that student. The student is able to access the education material from multiple devices, so the system determines which device the student is currently using, and adapts the educational lesson for the current device. Depending on the student's advancement through the lesson, the lesson is adapted to the students progress, and the educational goals are updated to reflect the student's performance. Also, the system may reward the student for successful progress, and may send reports to parents, teachers, or others involved in the student's education.

This application is related to U.S. patent application Ser. No. 11/296,077, filed Dec. 7, 2005, and entitled “Wireless Controller Device”, which is incorporated by reference in its entirety.

### BACKGROUND

The field of the present invention is education applications that are accessible using remote communication devices. More particularly, the present invention relates to an educational network configured to enable a student to access education applications from a variety of communication devices, including a wireless mobile handset.

Wireless devices are widely used today, and their use is becoming more widespread as additional applications and devices become available. Also, the network infrastructures have improved wireless coverage, as well as communication quality and speeds. For example, a wireless mobile handset has improved to the point where the mobile handset may have a wide range of entertainment applications, as well as its essential communication capabilities. With these extended capabilities, the wireless handset has become the most widely deployed and most conveniently available remote wireless device. Many users consider their wireless handset to be an essential partner, both in business and in their personal lives. As such, these users almost always have access to their wireless handsets, and are comfortable carrying and using the wireless handset in almost any environment. The wireless handset may take the form of a traditional wireless phone, or may be included with a personal data assistant, gaming device, or music player, for example.

With hectic current schedules and activities, it has become increasingly difficult for students to timely and fully complete educational lessons, and increasingly frustrating for parents and teachers to track and reward a student's progress. Further, students typically have access to several communication and entertainment devices, which too easily pull the student off track. For example, a student often has access to multiple computer systems, gaming consoles, wireless handsets, portable computing devices, and increasingly, an IPTV system. What is needed, then, is a system that enables parents, teachers, and students to more effectively use their communication devices to benefit a student's education.

### SUMMARY

Briefly, the present invention provides a system and method for using common communication devices to deliver educational lessons to students. The system is able to determine that an authorized student is attempting to access an educational program, and retrieves educational goals and progress information specific to that student. The student is able to access the education material from multiple devices, so the system determines which device the student is currently using, and adapts the educational lesson for the current device. Depending on the student's advancement through the lesson, the lesson is adapted to the students progress, and the educational goals are updated to reflect the student's performance. Also, the system may reward the student for successful progress, and may send reports to parents, teachers, or others involved in the student's education.

In one specific example, a student uses a wireless mobile handset to access an educational server. The server authenticates the student, retrieves an educational plan for that student, and determines how far the student has progressed throughout the lesson plan. The system sends the next lesson, receives responses from the student, and updates the progress log as the student moves through the lesson. In this way, if the lesson plan is interrupted, the student can pick up where they left off, without repeating or skipping material. Importantly, the student may pick up using the same wireless handset, or may use a different mobile or stationary device. The student's progress will be used to update the student's education goals, and may be reported to parents and teachers. Further, the system may track entertainment choices made by the student, which may be used to further adjust educational goals or rewards.

Advantageously, the disclosed educational system enables parents, teachers, and third parties to effectively and efficiently participate in a students educational progress. Further, the education system enables a highly efficient delivery of education content, and in a form and on devices popular and readily available to students. In this way, students are able to complete assignments when and where convenient, and are able to productively use educational time.

### BRIEF DESCRIPTION OF THE DRAWINGS

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views. It will also be understood that certain components and details may not appear in the figures to assist in more clearly describing the invention.

FIG. 1 is a diagram of an educational system in accordance with the present invention.

FIG. 2 is a diagram of an educational system in accordance with the present invention.

FIG. 3 is a diagram of an educational system in accordance with the present invention.

FIG. 4 is a diagram of an educational system in accordance with the present invention.

FIG. 5 is a diagram of an educational system in accordance with the present invention.

FIG. 6 is a diagram of an educational system using an IPTV in accordance with the present invention.

FIG. 7 is a diagram of an educational system capable of displaying content to different display devices.

### DETAILED DESCRIPTION

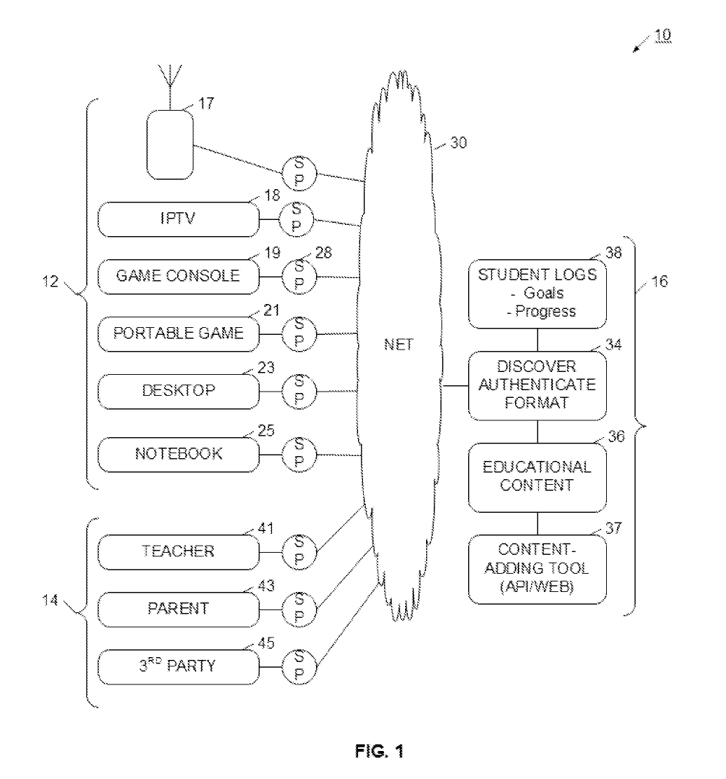

Referring now to FIG. 1, an educational system 10 is illustrated. Educational system 10 facilitates the convenient and controlled use of educational applications by a set of students. These applications may provide, for example, a series of educational lessons for advancing a student's proficiency in a field of study. Such fields could include math, history, chemistry, or other educational field. The lessons may provide advanced enrichment programs for a student, or may provide remedial practice in an area of difficulty. The lessons may also be self-sufficient, or may be part of a more comprehensive educational program that includes textbooks, classroom discussion, and labs.

In today's world, students often have access to more than one communication device. For example, a student may own or have access to a wireless mobile phone 17, a game console 19, a portable gaming system 21, a desktop computer system 23, and a notebook computer 25. The student may also have other communication devices such as text pagers, and portable PDAs. In some cases, the students may also have access to IPTV 18 (TCP/IP based TV), which is used to deliver selectable content via the Internet. An IPTV may be used as part of a classroom setting, as part of a home system, or as part of an other computer or displays system. Typically, these communication devices may connect through a service provider, such a service provider 28, to allow connection to a wide area network such as the Internet 30.

Advantageously, the student is able to have student access 12 from any available communication device, and may proceed through lesson plans at a time and place convenient to the student. These lesson plans and educational content are stored on an educational server 16. The educational server 16 may be a single server device, or may have its functionality distributed over multiple computers. The educational server 16 has educational content 36 relevant to a wide range of educational topics and educational levels. For example, the educational content may include lesson plans on mathematics, chemistry, biology, history, and other topics. Also, the educational content 36 may include lesson plans directed to grades 1 through 12, or may include advanced college course material. Since the educational content has such a broad coverage, the server has additional processes that select the specific lesson for a student according to the individual student requirements.

The server 16 also has content-adding tools 37 for allowing teachers, parents, or third parties to add new content or adjust current content. These tools 37 may be in the form of an API (application programming interface) command set and protocols, or may be a more user-friendly web or graphical interface. It will be appreciate that tools 37 may take many different forms.

The educational server 16 also maintains student logs 38 that define individualized educational goals for each student, as well as for tracking progress made through the educational plan. The educational server 16 also has functions that enable the educational server and the communication device to discover and authenticate each other, as well as to format lesson plans for the specific device the student is currently using. For example, a lesson plan intended to be displayed on desktop 23 may include wideband video, large textual displays, large images, and high quality audio. However, if the student were accessing that content using a wireless mobile handset 17, the educational server may format the lesson plan to include lower bandwidth video, smaller textual displays, and break the lesson plan into smaller media segments. In this way, a lesson plan may be usefully presented on the device the student is currently using.

The student logs 38 may also be used to track entertainment choices made by the student. The devices 18, 19, 21, 23, and 25 are the devices that a student may typically use to play games, watch videos, listen to music, or communicate with friends. Accordingly, a student's choices for free-time activities may be used to adjust that student's educational goals, as well as be integrated into reporting functions. For example, a student may choose to watch an IPTV program on hurricanes. If the student is currently studying weather in science class, the student may obtain additional bonus points, or may obtain a reduced assignment. In this way, the system 10 also may assist the student in making better choices for use of discretionary time. Also, the devices 18, 19, 21, 23, and 25 may have systems or processes that enable the system 10 to reward the student with more entertainment usage dependant on educational performance. For example, the student might earn an additional hour on game console 19 by completing a progress test with a high grade. It will be appreciated that more complex reward systems may be implemented.

The educational system 10 also enables education coordinator access 14. The educational coordinator access 14 enables teachers 41, parents 43 and approved third parties 45 to access the educational server 16 to set or adjust student goals, and to obtain reports as to student progress. For example, a teacher in the student's regular classroom may access the educational server for a particular student, and set or adjust a lesson plan for that student. The lesson plan may include a defined flow of presentation material, as well as challenge or review questions to assure the student understands the material. The lesson plan may also include information regarding the student's learning style, so that the pace and lesson content may be adjusted to the individual students needs. For example, some students have a learning style that allows them to move quickly through new concepts, as these students enjoy the challenge of struggling with new concepts. However, other students may need a more paced presentation, where concepts are introduced more slowly, and more positive reinforcement is given as understanding increases. Moreover, some students may need more examples, illustrations, and practice challenge questions in order to grasp the same material as others. In one example, the teacher is able to input student learning style using simple graphical tools. In this way, a lesson plan may be set for an entire class of students, but the educational server automatically adjusts the individual lesson plans according to individual student characteristics.

The educational server may also be set to automatically generate messages upon certain events. For example, teachers, parents, or third parties may be notified when a student reaches a particular goal, or if the student fails to perform assigned tasks according to plan. Parents may also access the educational system, and may be able to update or adjust the learning characteristics set by the teacher. In this way, parents and teachers can actively cooperate to tune educational programs for the needs of each student. In a similar way, a third party, such as a psychologist, may access the educational server to further adjust and tune learning criteria. By enabling a closer communication and cooperation between teachers, parents, and educational support personnel, educational system 10 allows for an improved learning process for each individual student.

An example may assist in understanding the advantages in educational system 10. In this example, a teacher 41 accesses the educational server 16 and defines a lesson plan or other educational goals for a student. The teacher may also invite a parent or an educational partner to further adjust the educational plan or the learning characteristics of the student. The educational server 16 may send messages to the student to inform them that a lesson plan has been assigned and is available for use. During a study period at school, the student may use a computer in the school's computer lab, which may be a notebook computer 25, to access the educational server 16. The educational server uses discovery and authentication processes, which will be described in more detail later, to assure that the proper student is using the system. The educational server also recognizes that the student is using a particular notebook computer, and will therefore format 34 any content according to the notebook's capability and characteristics.

The educational server retrieves the lesson plan for the student, and determines that the student has not yet performed any tasks in the new plan. The educational server retrieves the first lesson plan from the educational content area 36, formats that information, and transmits it to the notebook 25. The student is then able to view presentation material, and may be required or requested to provide input to the educational program. For example, the student may be given some flexibility in the progress of the lessons, or the educational software may occasionally ask challenge questions to assure the student is understanding the material. Based on the responses and progress to the lesson plan, the educational server will log the students progress, and provide the next lesson plan. The pace and content of the lessons may also be adjusted according to the specific learning characteristics defined for that student. At the end of the study period, the student disengages with the educational server, and continues through their classroom day.

At the end of the day, the student may have a long bus ride home, and use their wireless mobile handset 17 to continue his or her assignments. In this way, the student uses the wireless mobile handset 17 to access educational server 16. Educational server 16 again discovers and authenticates the student, and recognizes that the student is now using a wireless handset, so formats the lessons plans differently for use on the handset. The educational server retrieves the student's educational plan and progress logs, and proceeds from the point where the student had previously left off. The student then may view educational material and interact with the educational server using the wireless handset. As the student nears home, they will logoff the wireless handset and proceed with their afternoon activities. Later, when it is homework time at home, the student may use their desktop computer 23 or game console 19 to again access the educational server. In a similar way, the educational server will discover and authenticate the student, and format the educational plans for the device the student is currently using. Since the educational server has carefully tracked the students progress to the lesson plan, the student begins the evening lessons from the point where they left off on the school bus. In this way, irrespective of the students location or the device they are using, they are able to seamlessly proceed through an educational plan. Upon completion, or upon failure to meet minimum goals, an e-mail or other message may be sent to the teachers and parents. For example, if a student is to have read an entire chapter in a history assignment, and has failed to do so by 9 p.m., the system may automatically send an e-mail, or even generate an automated telephone message to the parents, letting them know their student is behind on that day's assignment. Also, parents may access the educational server at any time to confirm progress.

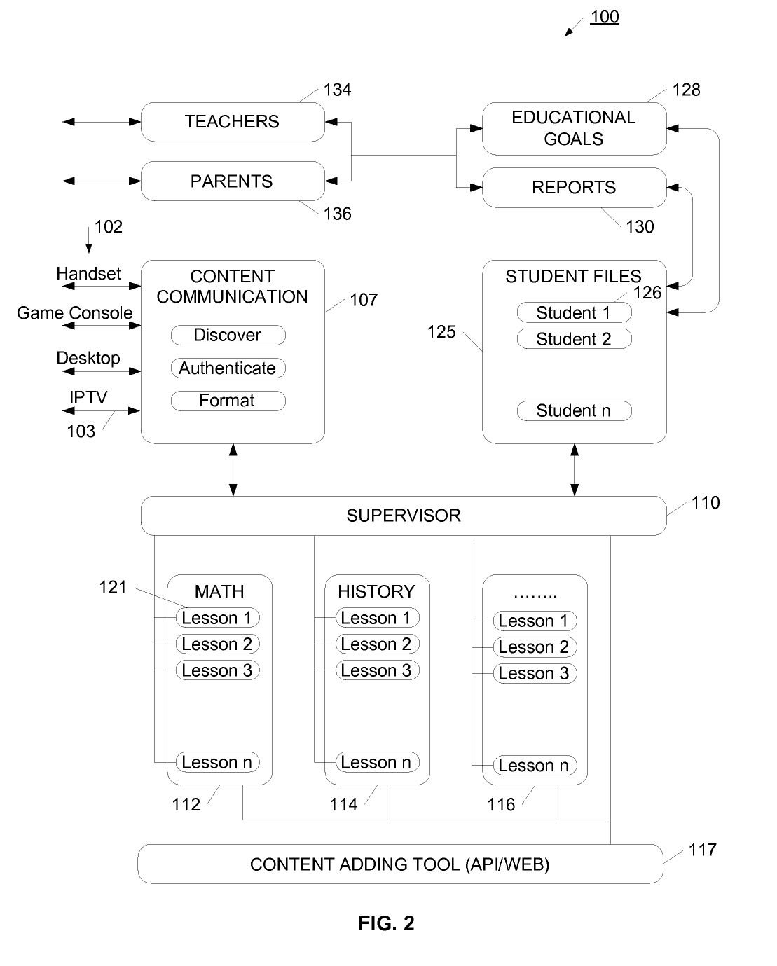

Referring now to FIG. 2, a block diagram of an educational system 100 is illustrated. Educational system 100 has a student that has multiple communication devices 102. These communication devices may include wireless mobile handsets, game consoles, desktop computers, PDAs, pagers, notebook computers, or other mobile or stationary devices. The system may also have an IPTV, which enables a student to remotely access and control the delivery of video programs. These programs may be educational, or may be more entertainment oriented for viewing during free time. The educational system 100 has a content communication block 107, which is used for establishing and maintaining secure communication with the student. More particularly, the content communication block 107 is used to confidently discover and authenticate the student and device, as well as to assist in formatting material to the needs of the device the student is currently using. Copending U.S. patent application Ser. No. 11/296,077, filed Dec. 7, 2005, and entitled “Wireless Controller Device”, is incorporated herein in its entirety, and more fully describes systems and processes for discovering and authenticating user devices, and for using the device's for remote control and communication. It will be appreciated other similar processes may be used.

A supervisor program 110 has access to student files 125. In this way, supervisor 110 may view educational goals and progress logs for individual students such as the student 126. Whenever a student logs into an educational session, the supervisor may access the student file, and determine the educational plan for that student, as well as how far the student has progressed through the plan. The student files may also include information regarding educational choices made by the student, as well as control information as to allowed usage on one or more devices 102. Using the student information, supervisor 110 may then extract the appropriate next lesson from the educational programs 112, 114, or 116. Each of these educational programs may be associated with a particular technology, field of education, textbook program, or individualized teacher plan. For example, educational program 112 may have lessons, materials, and questions which track lesson plans in a classroom textbook. In this way, the educational program 112 is easily adapted to support daily activities of the teacher.

Once the supervisor has retrieved a students lesson plan, and has confirmed current progress, the supervisor may retrieve a particular lesson, such as lesson 121, and pass that lesson plan to the content communication block 107. The content communication block formats the lesson plan according to the characteristics of the communication device the student is currently using, and passes the information to the student. The student then interacts with the educational program, for example, by answering challenge questions. The student's answers are received by the content communication and the supervisor 110, and the responses are logged in the students file 126. Depending on the student's defined learning style, the supervisor may then send more difficult material, remedial material, or move on to a new topic. It will be appreciated that the pace and characteristics of the individualized learning plan may be properly adjusted according to the needs of the individual student.

Importantly, each time the student interacts with the educational server, the student's interaction is recorded in the student file. In this way, the educational server is aware of the student's current progress, so the student is free to start and stop learning at any time, as well as to move between communication devices. Teachers 134 and parents 136 may also access the educational server through their communication devices. The teachers and parents will access educational goal processes 128, where they are able to set and adjust educational goals for an individual student. For example, a teacher may set a general education goal for each member of a class, and then adjust some students according to particular learning needs. A parent may then access the educational goals 128 for their son or daughter, and further refine and tune the educational plan for the needs of that student. The educational goals may not only include the academic plan and goals, but may include learning style and characteristics for each individual student. This information may then be used by the supervisor in determining the order and pace for lesson plans and challenge questions. The teachers and parents may also access reports 130 which detail a students progress through the educational program. It will be understood that the reports may be accessed manually, or maybe generated automatically by the system and forwarded to the parents and teachers. Educational system 100 thereby enables convenient student access, an individualized educational program, as well as accountability for student progress.

Third parties, such as educational experts, and teachers may use a content adding tool 117 to add or adjust content in one or more of the educational programs, or to make an entirely new educational program. This tool 117 may be in the form of an API (application programming interface) command set and protocols, or may be a more user-friendly web or graphical interface. It will be appreciate that tool 117 may take many different forms.

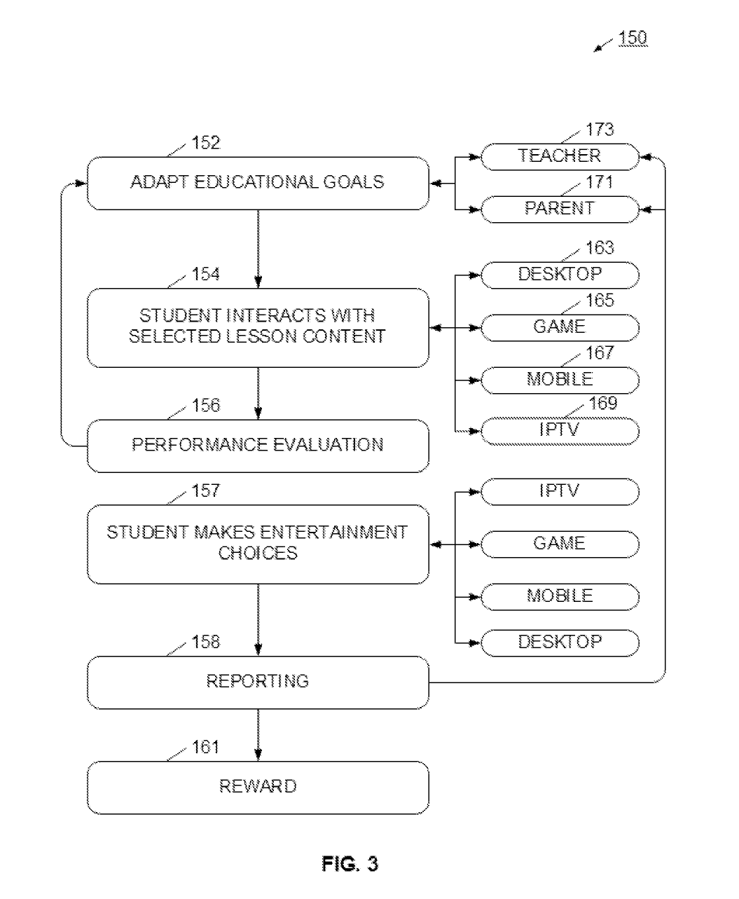

Referring now to FIG. 3, a system process 150 is illustrated for an educational program. In process 150, teachers 173 and parents 171 cooperate to set educational goals for a student as shown in block 152. These educational goals may set out academic plans, as well as identify particular learning characteristics for the student. In this way, content may be selected and presented according to the individual learning characteristics of a student. A student is able to receive the educational material as shown in block 154. Advantageously, the student may access the educational material using any of their available communication devices, such as a desktop computer 163, a console or portable gaming device 165, or their wireless mobile handset 167, or a IPTV. Irrespective of which device they use, the student may access the programs, and the system will maintain a log or file of their progress, so that a student may proceed through a lesson plan without repeating or missing sections.

Periodically throughout the lesson plan, the lesson plan may provide challenge questions or other inputs from the student and perform a performance evaluation as shown in block 156. For example, the educational system may track percentage of questions answered correctly, or may evaluate how quickly the student is progressing through a reading assignment. The result from the performance evaluation 156 may be used automatically to adjust the educational goals 152. For example, if a students progress has slowed through a particular topic, the system may automatically adjust the lesson plan to provide more material on that topic, thereby giving the student more time to absorb and understand this concept. In a similar manner, if a student is progressing very rapidly through a section and answering all questions correctly, the system may recognize a student thoroughly understands this topic and progress to a new topic. Since the student may use devices 163, 165, 167, and 169 during discretionary free time, the system may also log and track entertainment choices made by the student as shown in block 157. For example, the student may choose to watch a news program during his or her “entertainment” time. This positive entertainment choice may be used to adjust the lesson plans to reward the student, or may be used to increase other positive rewards, and to make a positive report to parents and teachers.

The performance evaluation 156 and student choices 157 may also be used as a basis for performance reporting 158 so that reports and status updates may be sent to students, teachers, and parents. In this way, the teachers and parents may use the reports to further adjust educational goals. By providing both automated and coordinator of feedback, the educational system may be finely tuned and adapted to the learning styles of individual students. The system may also provide for a reward 161 if the student successfully completes a lesson. For example, the reward may allow for additional gaming time, telephone use time, or other activity desired by the student.

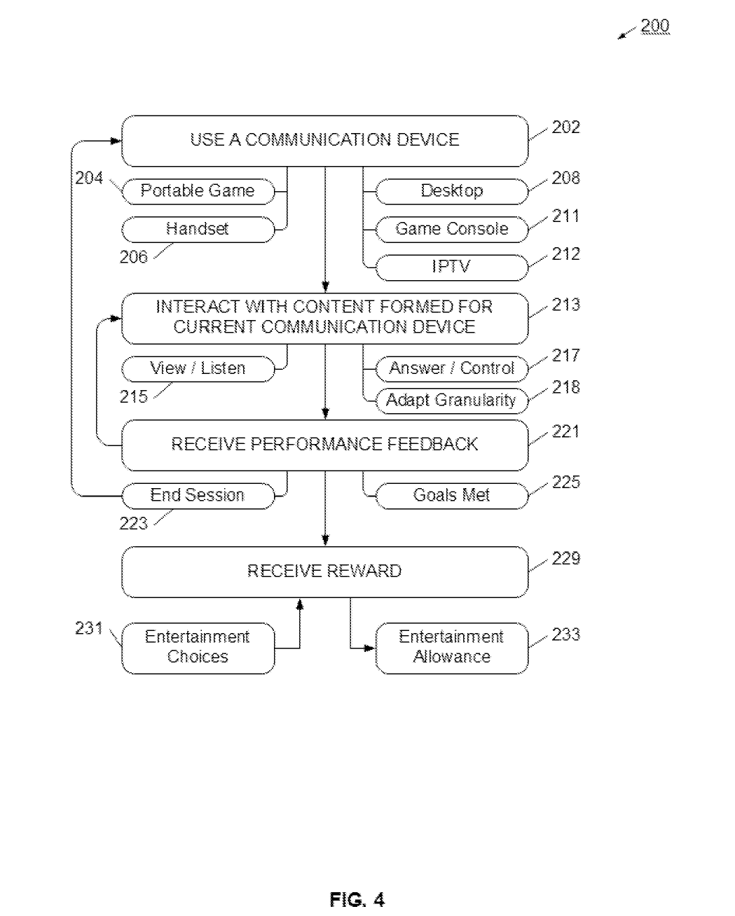

Referring now to FIG. 4, an educational process 200 is illustrated from a student perspective. In method 200 a student uses a communication device 202. The student may have multiple devices to select from, such as a portable gaming system 204, a wireless mobile handset 206, a desktop computer 208, an IPTV system 212, or a gaming console 211. Depending on their location and device availability, the student may use any of the available devices. The student logs in and establishes a session with the educational server, and interacts with content using the communication device as shown in block 213. The student will typically view or listen to presentation material as shown in block 215, and may be requested to answer challenge questions as shown in block 217. In this way, the educational server can determine if the student understands the presented material. Depending on which device the student is currently using, the system 200 may adapt the granularity of the material 218. For example, if the student is using a desktop computer with a highly reliable connection, the system 200 may send relatively large sections of material, and allow the student to work locally, with occasional updates and progress reports to the server. However, if the student is on a less reliable wireless connection, then the system 200 may adapt to send small sections of material, and may require continual reports back to the server. In this way, the system 200 can confidently assure that the student is participating in the complete educational program, while reducing the amount material duplicatively sent to the student.

The student will also receive performance feedback as shown in block 221. This performance feedback can be in the form of visual messages, audio messages, or a reward. The student continues working through the lesson plans until they end the current session as shown in block 223, or they have met all the goals in the current lesson plan as shown in block 225. If they end their current session before finishing the lesson plan, they may continue the lesson plan at a later time using any of their available communication devices, and the system will continue where they left off. If the student has completed their goals, then they may receive some sort of reward as shown in block 229. This reward may be, for example, additional allowance 233 for phone, gaming, or leisure time. The type of reward may be set by the teacher or parent, for example. In another example, entertainment choices 231 made by the student may be used to further reward the student, or to adjust the educational program.

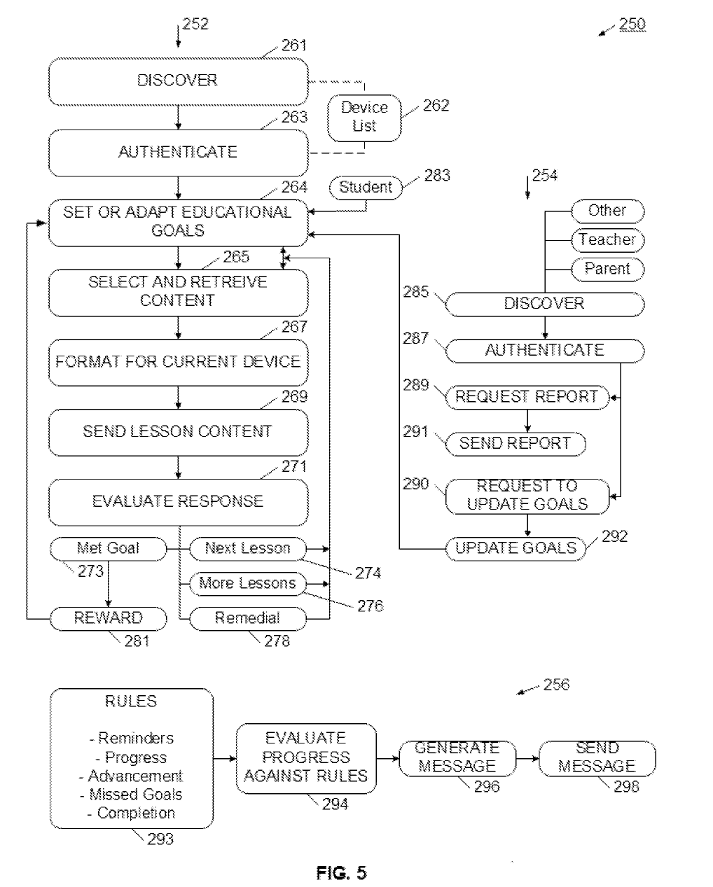

Referring now to FIG. 5, an educational process 250 is illustrated from a server perspective. In the process 250, system integrity and security is an important feature. For example, it is important that only authorized teachers and parents be able to set and adjust educational goals and view student performance, and it is also important that only the approved student be allowed to work on academic material. Accordingly, system 250 has a robust discovery 261 and authentication process 263. A detailed discussion of a discovery and authentication process is described in U.S. patent application Ser. No. 11/296,077, filed Dec. 7, 2005, and entitled “Wireless Controller Device”, which is incorporated by reference in its entirety. Generally, the discovery process 261 is used to identify particular communication devices for a student, and apriori define access means and key pairs for each device. In this way, the server is aware how to find communication devices, and is able to authenticate that an approved device is being used. Further, secure session keys may be defined to assure that individual communication sessions are also secure. The system maintains a device list 262, according to individual students, for defining approved devices, as well as maintaining information on how to access and secure communications to those devices.

When a student desires to log into the system, the system uses the device list information to discover and authenticate that device, and then retrieves the particular educational goals 264 for that student. These educational goals will set out the particular academic plan, the student's learning style, as well as progress-to-date the student has made. The system then retrieves content selected according to the educational goals as shown in block 265. This content is selected from all available academic material, which may cover several educational fields and several academic levels. The server forms the content according to device characteristics as shown in block 267. For example, content may be formed differently for a small display screen on a wireless phone as compared to a large computer screen on a desktop computer. The server sends the content to the student as shown in block 269, and then evaluates responses made by the student. These responses could be, for example, answers to challenge questions, or may be the rate at which the student is requesting additional pages or chapters of information. Depending on how the student is progressing, the system may determine that the student has met his or her goals as shown in block 273, in which case the system may provide a reward as shown in block 281. The system may also determine that the student is ready for the next lesson as shown in block 274, but student may need more lessons in the same material as shown in 276, or may even determine that the current material is too advanced for the student and begin providing remedial lessons as shown in block 278. The results from the evaluation are used to adjust the educational goals and are used to update the progress tracking for that individual student. Accordingly, the student is allowed to work through material at their own pace, while the system automatically adapts and adjusts the educational program to the student's learning style, as well as the actual performance of the student against that material.

System 250 also allows coordinator access 254. These coordinators may be teachers, parents or third party such as a psychologist. In a similar way, when the teacher, parent, or third-party desires to access the system, their devices are also discovered and authenticated as shown in blocks 285 and 287. Depending on the access rights of the particular teacher, parent, or third-party, the coordinator may be able to request certain reports on student progress as shown in block 289, or may be able to request a change to the educational goals as shown in block 290. For example, a teacher may have full access rights to the entire student file, whereas a parent may only be able to change the learning styles for the student. In a similar manner, some third parties may only be able to track progress, and may not be able to adjust educational goals. It will be appreciated that access rights may be set according to individual circumstances. When a coordinator requests a report, provided they have proper access, the system may send a report as shown in block 291. If the coordinator has the proper access rights, then the coordinator may be able to adjust and update educational goals as shown in block 292. These updates are then received by the system and used to select and adjust individual lessons sent to the student.

System 250 may also have automated processes 256 used to automatically monitor and report student progress. For example, the monitoring system may have a set of rules defined for a particular student or set of students. These rules may be set according to a desired reminder schedule, a progress schedule, missed goal schedule, or met goal rule. The student's progress is monitored against these rules as shown in block 294, and when a ruled is met, a message is generated in block 296. This message may then be sent to the student, teacher, parent, or third-party as defined in the rule and as shown in block 298. For example, a rule may be set that a student is to have all lesson plans completed by 9 pm. If lesson plans are not completed, then an e-mail or phone message may be generated to the parent. In this way, the parent may take required action at home to assure that the plan is completed in a timely manner. In another example, the automated processes 256 may be used to send reminders to the student that work is still incomplete. For example, if an assignment is due the next day, the system may automatically generate a message reminding the student that the plans are not yet complete. In this way, the student is able to complete the lesson without prodding from a parent or teacher. In a final example, the system may monitor for when the student has successfully completed a major section of the plan. In this way, teachers and parents may be notified of successful progress, and may take steps to appropriately praise or reward the student. Accordingly, system 250 provides an educational system that is tuned and adapted to the learning styles and needs of individual students, enables accountability for all participants in the educational system, and is easily and flexibly used by the individual student.

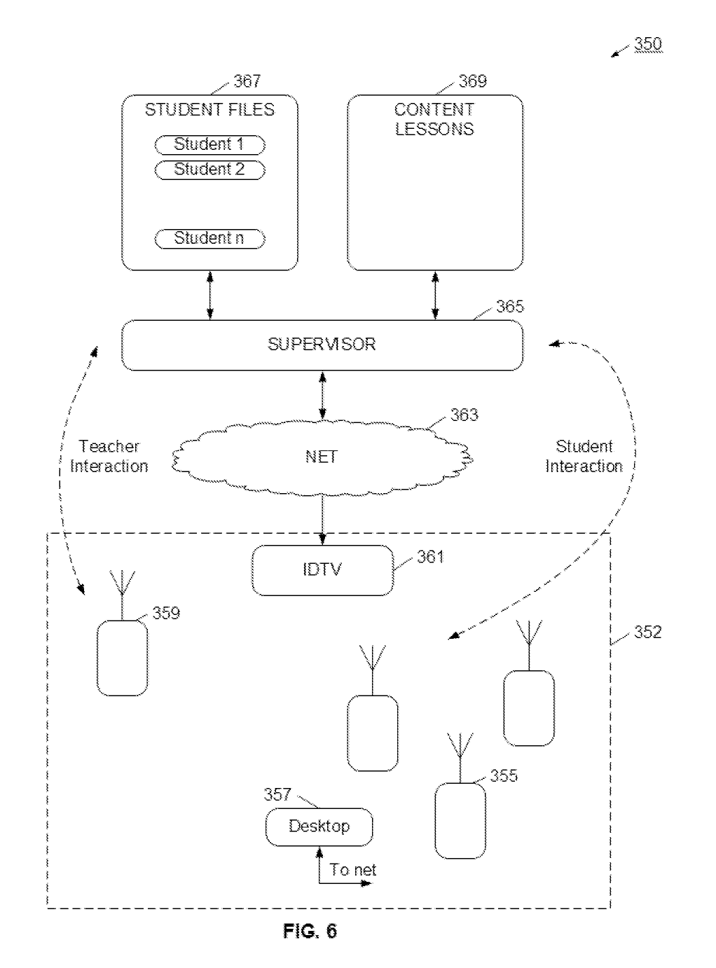

Referring now to FIG. 6, an educational system 350 is illustrated. Educational system 350 has a classroom environment 352 having multiple students, with each student having a communication device. Some students may have a wireless handset 355 as a communication device, while others may be accessing through notebook or desktop computers 357. A teacher may also have an input device such as wireless handset 359. In the classroom environment, an IPTV 361 is used to augment classroom material and discussion. The teacher may lead discussions and discuss material being shown on the IPTV. Students may be responding to challenge questions presented at the IPTV or by the teacher, and those responses accepted by a supervisor program 365 operating on an educational server. The supervisor is able to track and log the response from each individual student in the student logs 367, and then use the responses to adjust the content displayed on IPTV 361. For example, the supervisor 365 may receive responses from students in classroom 352, and determine when nearly all the students have adequately understood the current concept. At that point, the supervisor would instruct the IPTV controller to advance to a new topic. In a similar manner, if the supervisor 365 determines that many of the students in classroom 352 are not understanding the current topic, the supervisor 365 could instruct the IPTV controller to send additional information on the same topic, or even send remedial information. In this way, the individual responses from students using communication devices are used to pace and adapt a classroom presentation. Of course, teacher 359 may have further control ability to adjust the program pace according to his or her in-class experience. By using system 350, an in-class automated presentation may be used that is far more valuable than the standard educational multimedia presentation. For example, system 350 enables a presentation that is paced and adjusted according to actual student learning characteristics, as well as actual student understanding.

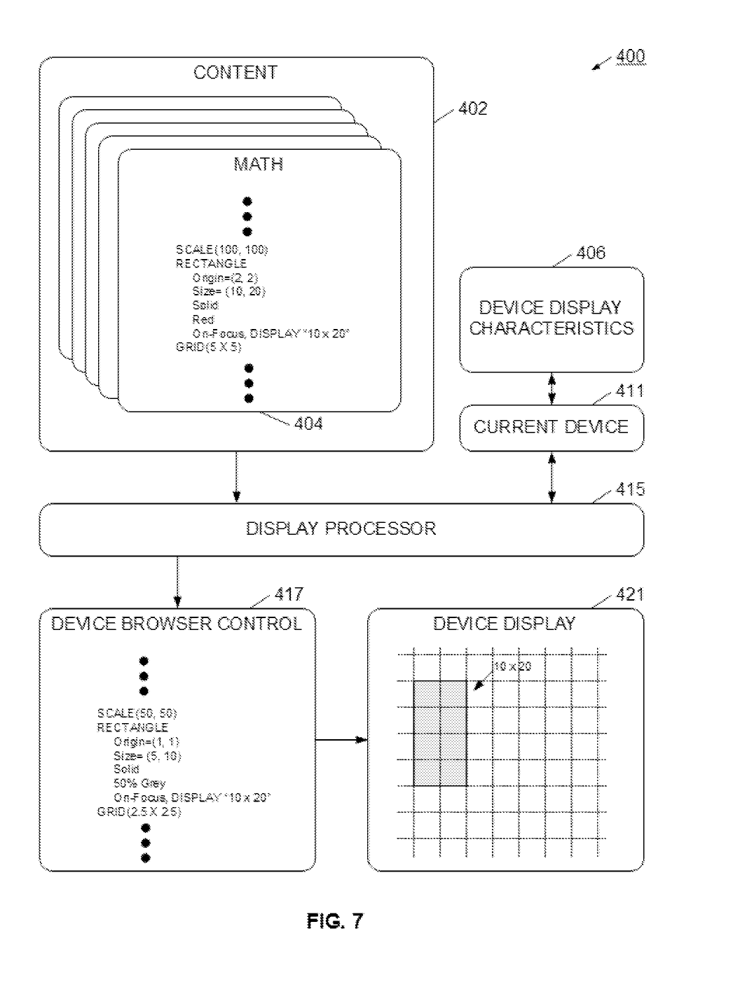

Referring now to FIG. 7, a display system 400 is illustrated. Display system 400 has a set of educational programs 402, typically provided in programs separated by discipline and level. For example, FIG. 7 shows a Math 404 discipline as one educational program. A discipline, such as math 404, typically has a language and protocol used by its professionals for effectively communicating material to a student. For example, the math discipline 404 may need special geometric shape definitions, set language, graph configurations, and formula control. To facilitate ease of developing educational programs, the systems 400 allows the discipline expert to build content files using discipline-specific language, and automatically adapts the discipline-specific language for the current device being used by the student.

In order to adapt the discipline-specific language, the system 400 has a characteristic file 406, which holds the display and device information for the devices usable by the student. This file may also be updated by system 400 by allowing the system to query new devices. Devices are often configured to report their capabilities responsive to a query. In this way, system 400 may automatically update file 406 to represent new devices. System 400 also is aware of the current device 411 being used by the student, and may retrieve or determine the display characteristics for that current device. System 400 has a display processor 415 that intelligently adapts the discipline-specific language of the content files 404 for use on the current device. More particularly, the current device operates a discipline-specific browser 417, which is capable of implement much of the discipline-specific language in the content files 402. However, because of limitations in the current device, some of the functionality in the discipline-specific language definitions may need to adjusted or removed, or new commands or functions added. As illustrated in FIG. 7, the display processor 415 has made adjustments to scaling and color settings so that the rectangle is properly displayed on the display 421 of the current device.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. An educational method for use by a student, the student having a plurality of available communication devices, including a wireless mobile device, the method comprising:
determining that the student is attempting to access lessons stored on an educational server;
discovering which one of the plurality of communication devices that the student is currently using;
authenticating the currently used communication device and initiating a communication session;
retrieving information that defines educational goals for the student and tracks progress-to-date information;
using the retrieved information to select and retrieve a next lesson;
formatting the retrieved information for the currently used communication device;
sending the next lesson to the currently used communication device;
receiving a response from the currently used communication device, the response indicating the student has completed at least a portion of the lesson; and
updating the educational goals and the progress-to-date information.

2. The method according to claim 1, further including the steps of:
ending the communication session;
initiating a second session with the educational server; and
using the updated progress-to-date information in selecting the next lesson.

3. The method according to claim 1, further including the steps of:
ending the communication session;
initiating a second session with the educational server using a second one of the communication devices; and
using the updated progress-to-date information in selecting the next lesson; and
sending the next lesson to the second communication device used communication device.

4. The method according to claim 1, further including the steps of:
ending the communication session and entering a second communication session, the second session comprising the steps of:
determining that the student is attempting to access lessons stored on the educational server;
discovering which one of the plurality of communication devices that the student is currently using;
authenticating the currently used communication device and initiating a communication session;
retrieving information that defines educational goals for the student and tracks progress-to-date information;
using the retrieved information to select and retrieve a next lesson;
formatting the retrieved information for the currently used communication device;
sending the next lesson to the currently used communication device;
receiving a response from the currently used communication device, the response indicating the student has completed at least a portion of the lesson; and
updating the educational goals and the progress-to-date information.

5. The method according to claim 1, further including the step of using student learning characteristics to select the next lesson.

6. The method according to claim 5, further including the step of receiving characteristic information from a teacher communication device or a parent communication device, and using the characteristic information to adjust the learning characteristics.

7. The method according to claim 1, further including the step of discovering the display characteristics of the communication devices that the student is currently using.

8. The method according to claim 1, wherein the step of updating the educational goals includes using information on entertainment choices made by the student.

9. A process operating on an educational server, comprising:
interacting with an education coordinator to adapt education goals for a student;
providing information regarding a set of available communication devices that the student may use to access the educational server;
determining which one of the communication devices the student is currently using;
selecting a lesson for the student according to the education goals;
formatting the selected lesson according to the current device's characteristics;
sending the lesson to the communication device currently used by the student; and
receiving a response from the current device indicative of the student's progress in the lesson.

10. The process according to claim 9, wherein the set of available communication devices includes a wireless mobile handset and at least one device selected from the group consisting of a portable gaming device, a gaming console, a notebook computer, a laptop computer, and a personal data assistant.

11. The process according to claim 9, wherein the education coordinator is a teacher, and the teacher uses a communication device to interact with the educational server.

12. The process according to claim 9, wherein the education coordinator is a parent, and the parent uses a communication device to interact with the educational server.

13. The process according to claim 9, wherein the response includes a response to a challenge question, and the response is used to further adjust the education goals.

14. The process according to claim 9, wherein the response includes an indication that the student has completed a section of the lesson, and the response is used to further adjust the education goals.

15. The process according to claim 9, further including the step of using the response to update progress-to-date for the student.

16. The process according to claim 15, further including the step of using the updated progress-to-date as an indicator of a next lesson to select for the student.

17. The process according to claim 9, further comprising the step of:
adapting the education goals according to response to the lesson.

18. The process according to claim 9, further comprising the step of:
adapting the education goals according to entertainment choices made by the student.

19. An educational method for use by a student, the student having a wireless mobile device, the method comprising:
initiating a communication session with the wireless mobile device;
retrieving information that defines educational goals for the student and tracks progress-to-date information;
using the retrieved information to select and retrieve a next lesson;
presenting lesson information on an IPTV;
receiving a response from the wireless mobile device, the response indicating the student has completed at least a portion of the IPTV lesson; and
updating the educational goals and the progress-to-date information.

20. The educational method according to claim 19, further comprising the steps of:
logging entertainment choices made by the student; and
updating the educational goals according to the entertainment choices.
